(19) United States
(12) Patent Application Publication
(10) Pub. No.: US 2004/0187411 A1
(43) Pub. Date: Sep. 30, 2004

(54) Concrete construction log

(76) Inventor: James D. Clegg, Nampa, ID (US)

Correspondence Address: DEREK H. MAUGHAN, DYKAS, SHAVER & NIPPER, LLP, P.O. BOX 877, BOISE, ID, 83701-0877, US

(21) Appl. No.: 10/400,609

(22) Filed: Mar. 25, 2003

(51) Int. Cl. E04B 1/10; E04C 1/00; B44F 9/00; B44F 7/00

(52) U.S. Cl. 52/233; 52/313

(57) ABSTRACT

The present invention is a system of “log-cabin” type construction wherein the “logs” or basic building elements are prefabricated reinforced insulated concrete modular construction pieces (“logs”) that are configured to have an outer surface that resembles a wooden log. These “logs” are variously configured to be interconnected and stacked so as to provide a durable efficient building system for a variety of desired types of building structures.

### BACKGROUND OF THE INVENTION

1. Field of the Invention.

The present invention generally relates to building structures, and more particularly to a system for building log-cabin style structures from pre-cast concrete building elements that resemble natural wooden logs.

2. Background Information.

Since the times of the early pioneers, individuals have constructed homes made of logs. These log structures can be constructed in a variety of ways with the end result generally being a structure that has an outer surface with the aesthetic appeal of the structural log portions being open to view. While originally this was probably done simply out of the lack of time or financial capabilities to cover these logs, this log facade style has developed into a desired aesthetic style. This is particularly true in the case of persons who enjoy the outdoors or in situations where the “log-cabin” look is desired, such as a vacation cabin or a ski lodge. Although a variety of other construction techniques and materials are presently available, log structures are still a desired style of structure for a variety of reasons.

“Log-cabin” style structures are typically made of wood. The exact system of assembling the logs to construct a home may vary. However, the steps involved in building such a structure are generally similar. First, the raw materials to make the logs must be obtained. This is typically done by harvesting rough logs from a stand of timber. These rough logs must then be modified and prepared for placement within a log cabin structure according to the necessities of the builder and designer. This may involve a variety of processes including cutting the logs to length, peeling the logs to remove bark and other excess unwanted materials from its surface, conforming the logs so as to allow the logs to be placed together, and placing and securing the logs together in the desired positions. After these logs have been placed and secured in the desired location, a roof can then be placed upon the device.

A variety of disadvantages exist in such a construction system. The first disadvantage is that the wooden logs must be harvested. This requires that trees be cut from existing stands of timber in forests or other settings. These natural resources require an extended period of time to grow and in some cases, consumption of these logs has outpaced the re-growth of such timber stands. Therefore, the raw timber from which log homes are constructed is becoming more and more scarce. In addition to the environmental and ecological complications that this engenders, this scarcity also makes these logs increasingly more expensive.

Another disadvantage of utilizing natural logs in building a log cabin is that wooden logs naturally vary in size, dimension and other various features. Typically, a log will decrease in circumference from a larger first end toward a smaller second end as it extends along a length. This difference in circumference is particularly noticeable in longer log pieces. In addition, logs will typically have a variety of other features such as knots, holes, misshapen portions, and deformities. These natural variations make additional variations and modifications of the logs necessary in order to provide a suitably stable structure for use. Depending upon the individual logs, this may require extensive amounts of work and time either at the building site or at a log preparation location.

Another disadvantage of using the natural logs in the construction of habitable structures is that the shape of the logs leave spaces that must be filled in order to both maintain the logs in a desired position and to prevent the unwanted passage of cold air into the structure and warm air out of the structure. Another disadvantage of natural logs is that they have a tendency to rot or weather when exposed to elements such as water. This can destabilize the structures that are formed by the logs and require that these logs be replaced at a later point in time. In addition to these factors, log construction simply cannot provide a structure with sufficient structural stability as other building materials such as reinforced concrete.

Therefore, what is needed is a building structure that has the appearance of natural logs that also has increased structural stability and increased resistivity capabilities found in other building materials such as reinforced concrete. What is also needed is a construction system that utilizes preformed, generally uniformly shaped structural pieces that can be placed and assembled in a desired location quickly and effectively. What is also needed is such a device wherein the preformed portions are configured to have an insulating portion and are capable of placement in a variety of locations. What is also needed is a device and method of building structures that have the aesthetic appeal of natural log structures, but have the increased strength of reinforced concrete.

The present invention meets these necessities in providing a constructing system for constructing homes having a “log-cabin style,” which have the strength of a reinforced concrete structure, as well as increased resistance features as compared to other types of building materials. The present invention also provides a system of pre-cast and pre-formed elements generally uniformly shaped structural elements which allow a device to be placed and assembled in a desired location both quickly and easily.

Additional objects, advantages, and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a system for constructing structures that have a “log-cabin” type aesthetic appearance. While the system is shown in the context of constructing a single level residence, it is to be distinctly understood that such a configuration is to be seen as illustrative only and not as limiting this construction system to a particular type of structure. It will become apparent that the structure in the present invention may be utilized in a variety of ways including in the construction of buildings with multiple floors, as well as in buildings having varied features and floor plans. The system of the present invention may also be suitably modified for use in the construction of other structures such as retaining walls and other devices.

The present invention is a system of “log-cabin” type construction wherein the “logs” or basic building elements are prefabricated concrete modular construction pieces. These prefabricated concrete modular construction pieces (“logs”) are configured to have an outer surface that resembles a wooden log. These “logs” are variously configured to be interconnected and stacked so as to build stable building structures and elements for a variety of desired types of structures.

In one embodiment, the prefabricated concrete modular construction pieces each have a top side, a bottom side, a front side, and a back side. If so desired, the top side and the bottom side can each be configured to have a generally flat portion to increase the ease of stacking the construction elements. The front side and the back side are each configured to have a generally semicircular shape so as to approximate the appearance of natural logs. The length, color, shape, and appearance of the prefabricated concrete modular construction pieces may be modified as desired so as to provide the desired natural log appearance characteristics, as well as to provide desired structural features for the construction of desired building structures. These “logs” may be made from a colored concrete mix so as to prevent the appearance of unsightly gray concrete patches from appearing when a portion of the log has been damaged or hit.

Within these “logs” a plurality of reinforcing elements assist to provide strength to the individual “logs” themselves, as well as to assist structures made from these “logs” to be adequately, structurally maintained in a desired orientation. A variety of reinforcing systems and elements may be utilized to support the concrete structure including traditional devices such as re-bar, as well as other devices such as carbon, aramid, fiberglass and polymer based reinforcing structures and methods. The reinforcing portions are configured to give the structural strength to the concrete log as would typically be found in a beam.

The “logs” may also be variously embodied to include materials which may decrease the weight of the “logs” themselves as well as items which provide insulating properties to the structures. These “logs” may include a portion or portions which are made of a core or foam material. These pieces may also be configured to have an internal core of an insulating material. This core allows the overall weight of the item to be decreased, as well as providing an insulating layer that assists to slow the transfer of heat through the walls of the structure.

The “logs” can be formed so as to provide a variety of structures that assist in stacking and holding the logs in a desired location. One of the ways that these structures can be maintained in desired positions and orientations is to provide a cup in the top side of an end portion of the “logs.” This cup located within a first log is configured to receive a bottom portion of a second “log” when the second “log” is placed in a generally perpendicular orientation with regard to the first log. The cup is configured to receive the second log in such a way that the topside of the first piece and the top side of the second piece are generally levelly displaced along the same lateral plane.

Another structure that can be utilized to maintain the structural stability of a wall formed by an assembly of “logs” are retaining rods, which are configured to pass vertically through passageways which are formed within the “logs.” In some embodiments, both the cupped end portion and the vertical retaining rod structure may be used to maintain the “logs” in a desired orientation. The “logs” may also be held together with a masonry-binding device such as grout. In some embodiments, any one of these methods either individually or in combination with other types of structures may be configured to hold and maintain the “logs” in desired orientations and positions with regard to the individual structure. In other embodiments, the “logs” may be configured to have specially formed ends which are configured to be placed within a column having a notched aperture, or receiving portion. This notched aperture or receiving portion is configured to receive the end portions of the logs and forms a channel in which the end pieces of the logs may be placed. This channel holds the end portions together and assists to maintain the pieces in a desired orientation, position and location.

The “logs” are formed by a process wherein a mold configured to form a preformed modular concrete piece is prepared. This mold may be configured to have the appearance of a log, as well as the desired length, circumference, number, and size of apertures as desired by a user. Once the properly dimensioned and sized mold is selected, concrete is poured into the device and allowed to harden. When this concrete has properly cured and hardened, the mold is removed and the “log” is ready for use in building structures.

In some applications, a variety of modifications may be made to this process to achieve a variety of desired end results with regard to the logs that are formed by this process. In some embodiments, an insulating element may be placed within the mold so as to provide a “log” construction element that has increased insulating properties. In other embodiments, a reinforcing structure may be placed within the mold to provide increased structural strength to the element which “logs” which are formed from the device. Once the mold is prepared, it is filled with a concrete composition that is configured to form a hardened matrix having desired structural strength, weathering resistance, and aesthetic qualities. When the concrete composition has sufficiently dried and hardened, the newly formed “log” and the mold are separated. If so desired, the concrete log can then be passed along for additional work such as finishing, painting or sealing.

These pre-cast modular concrete logs provide a variety of advantages over the wooden pieces used in the prior art. These pre-cast modular concrete logs have increased strength due to the inclusion of reinforced concrete. These pre-cast modular concrete building pieces also have the ability to better resist water and weather damage than the wooden logs in the prior art. The preformed modular concrete logs of the present invention are also insulated to better control the flow of heat into and out of a device. These devices can also be preformed of a desired length, and can be configured to have generally uniform characteristics thus allowing these pieces to fit together in a desired orientation to form structures without having to cut the pieces to fit or otherwise prepare the pieces for assembly. Construction with these elements simply involves the placement of these preformed modular concrete devices in the appropriate positions, installing the reinforcing rods, if desired, and grouting the pieces together, if so desired. In some applications, such as the construction of a retaining wall, simply stacking the preformed modular concrete devices may be sufficient to hold some structures in place.

The purpose of the foregoing abstract is to enable the United States Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measure by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a front view of log of the present embodiment.

FIG. 2 is top, plan cutaway view of the log shown in FIG. 1.

FIG. 3 is a cross-sectional, end view of a log shown in FIG. 1.

FIG. 4 is an assembly view of a variety of logs shown in FIGS. 1-3 as arranged in one embodiment of a building construction.

FIG. 5 is a side view of the logs shown in FIGS. 1-3 in use within a structure.

FIG. 6 is a view of a structure made of the logs of the present invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

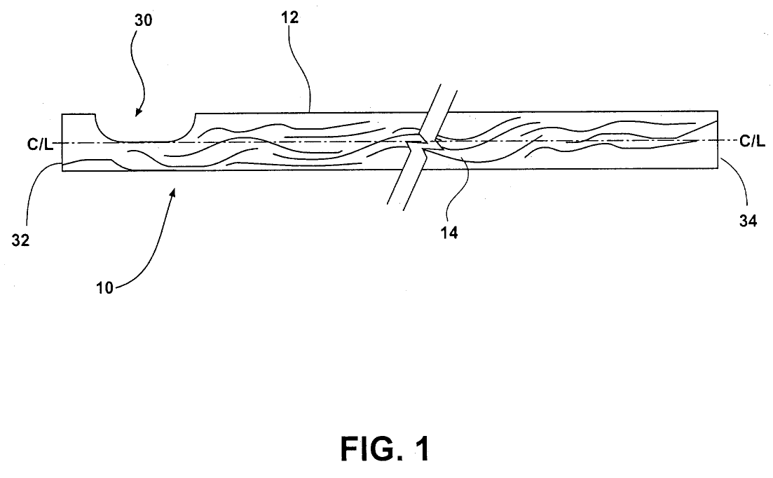

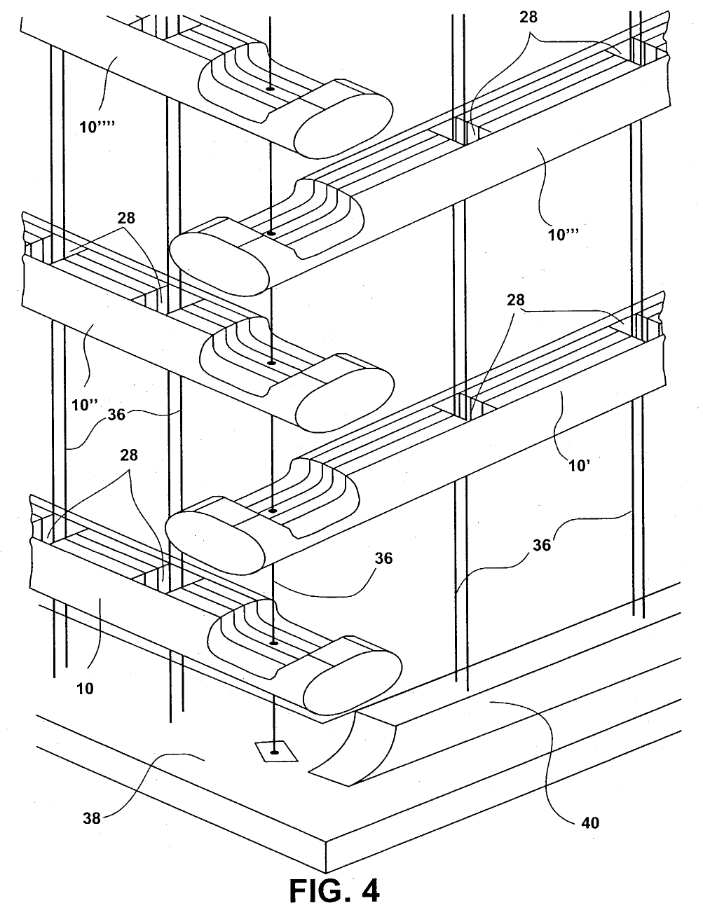

FIG. 1 is a front, plan view of a first embodiment of the preferred embodiment of the present invention. The invention is a pre-cast concrete log having top side 12, bottom side 14, first end 32, and extending along a desired length to a second end 34. The distance between the first end 32 and the second end 34 can be varied according to the various needs of the user depending upon the individual structures being utilized. Cup 30 is located near the first end 32 of the log. While in this invention cup 30 is defined near the first end 32 of the log, it is to be understood that similar cups 30 could also be positioned in a variety of desired locations along the portion of the log defined between the first end 32 and the second end 34 of the log. Each of these cups 30 is configured to receive a portion of a suitably adapted log or other construction element 10 therein. This assists the log portions 10 to be alternatively stacked so as to create structures. An example of such a stacking embodiment is shown in FIGS. 4-6 of the present application.

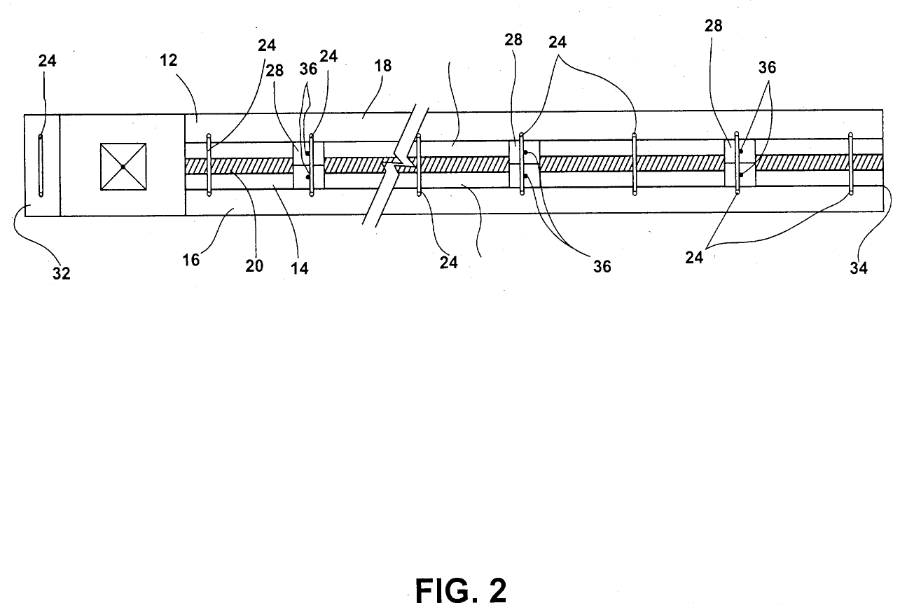

FIG. 2 is a cutaway, top plan view of the same preferred embodiment shown in FIG. 1. The concrete log 10 consists of an insulating core 20 preferably made of a rigid insulating material. In the preferred embodiment, such an insulation material would be a rigid form of insulation such as Styrofoam type insulation. However, it is to be distinctly understood that the material may be alternatively varied to achieve the desired results required by a user. In this preferred embodiment, this rigid insulation is configured to be about two inches thick. However, the amount of insulation required may be variously adapted depending upon the necessities of the individual user and/or the size and dimensions of the concrete log being formed.

Surrounding this two-inch rigid insulation is a reinforcing frame 22. This reinforcing frame 22 is made up of a plurality of generally c-shaped rebar portions 24 that are positioned linearly within the log 10 at generally one-foot intervals. These generally c-shaped rebar portions 24 are connected by rods 26 that run between the c-shaped 24 portions along the length of the log. The frame 22 and insulative core 20 are surrounded by concrete out to a distance about six and a half inches from the core out to, alternatively, the front 16 and back 18 walls of the concrete log 10.

This concrete is 4,000 p.s.i. concrete, that is further colored to provide a generally wood shaped texture. In addition, this concrete may be sealed with a variety of seals or dyes. The outer surfaces of the concrete log, particularly the front side 16 and back side 18, is configured to have a wood type texture and appearance. These cosmetic features may be varied to provide the desired aesthetic look for the project. In some other embodiments, a variety of other modifications, admixtures, and variations may be included to provide the logs with increased resistivity and strength producing capabilities.

Spaced along the length of the log within the generally rigid insulative core 20 are a series of reinforcement aperture passageways 28. These reinforcement aperture passageways 28 are configured to allow generally vertical passage of reinforcing rods 36 there through. These reinforcing rods 36 assist to straighten and hold the logs in a desired orientation and position. In addition, the reinforcing rods 36 are connected to a concrete footing 38 as is shown in FIG. 4.

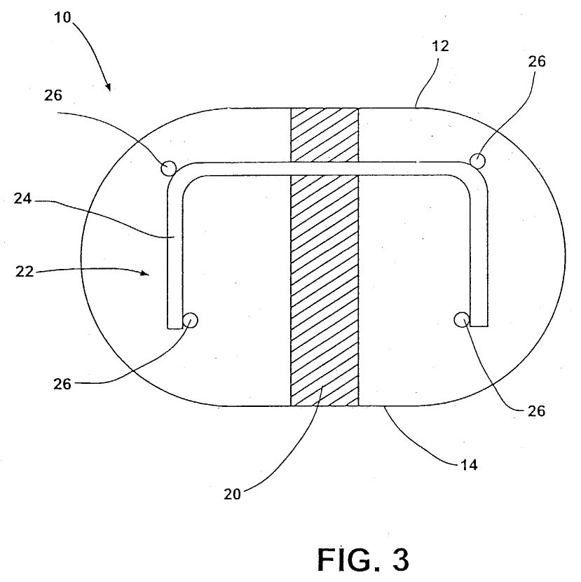

Referring now to FIG. 3, a cross-sectional end view of the concrete log 10 is shown. The rigid insulative core 20 is shown together with the reinforcing frame 22. The c-shaped rebar portions 24 are positioned so that the open portion of the c-shaped rebar portion 24 is directed in a downward orientation. The c-shaped rebar portions 24 are further reinforced by laterally running rebar rods 26 that are interconnected with c-shaped rebar portions 24 so as to form the reinforcing frame 22. The remaining portions of the concrete logs 10 are filled with a concrete matrix that forms and hardens around the insulative core 20 and the reinforcing frame portions. 22. The concrete log is positioned to have a generally flat top portion 12 and a generally flat bottom portion 14. These generally flat top 12 and bottom portions 14 allow for increased stability in placing these logs 10 in desired positions in constructing a desired structure.

FIG. 4 shows a plurality of prefabricated concrete “logs” 10 in use in the application of constructing a wall to form a part of structure. These construction elements 10 are placed in an orientation so as to build a wall. While this embodiment is shown as a preferred way of placing and assembling these elements, it is to be understood that the invention is not limited thereto but may be variously embodied to perform a variety of other types of structures having a variety of features.

In the preferred embodiment, a concrete footing 38 is poured and placed in a desired location as is required by local building codes. Rising out of this concrete footing 38 is a series of reinforcing rods 36. These reinforcing rods 36 are positioned to correspond with the spacing of the reinforcing aperture passageways 28. In the preferred embodiment, these reinforcement passageways 28 are positioned every two feet along the length of a log and correspond to intersect with a c-shaped rebar portion 24 of the reinforcing frame 22. A concrete leveling course 40 may be placed upon the footing so as to provide adequate spacing and support so as to level the top portions of the logs 10 when these logs are placed in a desired position and orientation. While a separate leveling course is shown in this figure, it is to be distinctly understood that the present invention is not limited thereto but may provide another means for leveling the top portions of the logs. For example, in an alternative embodiment, a specially formed “leveling log” may be utilized to achieve the desired results as set forth in this specification.

A first course of concrete logs 10 is laid in place upon the footings in an orientation and position wherein the reinforcing rods 36 pass through the internal passageways 28 that are defined within the logs 28. A second course of concrete logs 10′ is placed generally perpendicular to the first course and oriented in such a position whereby the bottom portion 14 of the second course of logs fits within the cup portion 30 of the first course of logs. The concrete leveling course 40 additionally has reinforcing rods 36 that are adapted and configured to pass within the reinforcement aperture passageways 28 within these concrete logs 10. By alternating the first and second courses to a third course 10″, to a fourth course 10′″ etc., a structure can be built that has a desired strength and structure so as to maintain the logs in a desired, stable position and orientation. It is also to be noted that in this preferred embodiment, a single reinforcing rod 36 is placed as configured to pass through the cup portion 30 of the device to assist in maintaining the connection between the concrete logs in a desired position at the corner positions.

When a desired height has been reached, a top log 48 is placed along the top portion of the device. The top logs 48 have bottom portions 14 configured to sit within the cup portions 30 of the other logs, but have no cup portions 30 of their own. The cups 30 are dimensioned to be sufficiently deep so as to allow the top portions 12 of a first wall to be generally level with the top portion 12 of a second wall. To assist in maintaining the connection between the various courses of logs, these concrete logs 10,10′, 10′″, 10″″, etc. are grouted together to maintain their stacked positions.

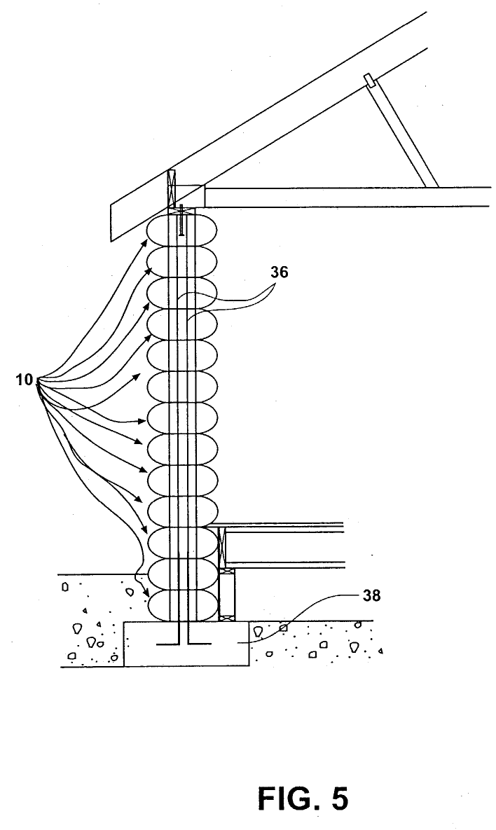

FIG. 5 shows a side view of the wall built with the construction elements shown in FIGS. 1-4. Each of these construction elements 10 are vertically stacked in a desired orientation with the front sides 16 facing away from the internal portion of the structure and the back sides 18 facing inwards towards the internal portion of the structure.

The reinforcing rods 36 run the course between the concrete footing 38 to a top log 48, which is configured to interact with typical roofing construction apparatus such as a sill plate. Depending upon the specific necessities of the builder, additional structural members may also be added that would allow second, third or fourth levels to be built upon this first level. In some orientations, connections to and between the concrete logs may be made with anchor bolts. The logs 10 are held together by grout and form an insulating, watertight outer structure with sufficient strength so as to be used for a variety of other uses.

Because of the configurations of the concrete, the concrete is much stronger than typical log constructions and provides many advantages. For example, in construction, the elements can be simply placed upon the footings and built upwards from that position. The concrete characteristics of the logs also allow for backfill to be placed up against the concrete portions of the structure. This cannot occur with wood because wood would rot if placed under the ground for extended periods of time. These logs can alternatively be molded to have a variety of other features that can assist in the construction of buildings. For example, joist hanger portions could be configured along the backside of the mold to provide a location for placement of floor joists or other features therein.

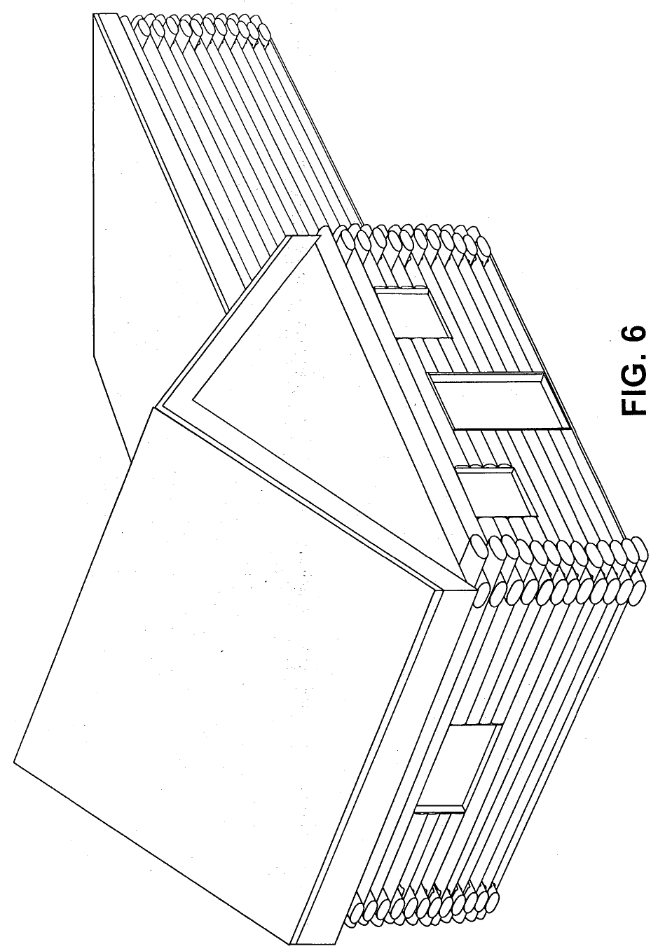

Referring now to FIG. 6, shown is a perspective view of a structure built with the prefabricated concrete modular construction elements. While a single level structure is shown in this figure, it is to be distinctly understood that the invention is not limited thereto but can also be utilized to construct a variety of other structures, including multiple story buildings, retaining walls, and the like. The structure provides a variety of advantages over the prior art of building a standard log cabin structure. By building structures of prefabricated concrete modular construction elements, the structure is more resistant to weather, water, and corrosion. This structure is also better insulated against both heat and sound. In addition, features can be built more quickly and efficiently because all of the portions for the device can be preformed into generally uniform sizes and dimensions and simply put in place at the construction site, rather than having to cut and adapt the logs as occurs in a typical log structure construction.

The logs for the present invention are made in the method wherein a mold, having the desired characteristics, in a generally open clamshell orientation. The inflating core and reinforcing frame are placed within the core and the core is then filled with a concrete mixture. The concrete mixture is 4000 p.s.i. concrete that is placed within the mold. In order to color the concrete, a pigmented color mixture is added to the concrete mixture. The coloring is placed within the concrete so as to prevent a generally gray colored concrete under portion from being revealed when damage occurs to the outer portion of the log. After the concrete has hardened and sealed, the mold can be removed and the log can be sealed with a sealant to prevent penetration of water or other elements into the concrete. This sealing coat provides additional protective qualities to the concrete log itself.

While the embodiment of a sealing coat has been shown, it is also to be understood that a variety of other methods may also be utilized for protecting, strengthening, and coating the concrete, and that the invention is not limited to the devices described in the present description.

This concrete log structure provides a variety of advantages and can be used in the construction of a variety of other structures and features besides buildings. It is envisioned that these prefabricated concrete modular construction elements could be used in a variety of orientations and constructions including foundation structures, retaining wall structures, and other devices wherein an insulating, strong, generally waterproof construction element is desired for use in an environment while still maintaining the aesthetic qualities of a log structure. While the present embodiment has been described utilizing the term pre-formed, it is to be understood that this term includes logs that are both pre-cast at a distant location, brought to a location for assembly and put together, as well as those pieces that are cast in place at a desired location.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A system for building structures having a simulated log structure appearance comprising:
a plurality of prefabricated concrete modular construction elements configured to resemble wooden logs, said prefabricated concrete modular construction elements further configured to be stacked and assembled in a manner so as to appropriately form stable building structures having the appearance of a structure made from wooden logs.

2. The system of claim 1 wherein said prefabricated concrete modular construction elements further comprise a reinforcing frame located within said concrete.

3. The system of claim 2 wherein said reinforcing frame comprises at least one generally c-shaped rebar portion connected to at least one other generally horizontally oriented rebar rod.

4. The system of claim 1 wherein each of said prefabricated concrete modular construction elements each have a top side and a bottom side, a back side and a front side log, said top side and said bottom side each having a generally flat surface configured for stable placement upon an adjacent prefabricated modular construction element.

5. The system of claim 1 wherein said prefabricated concrete modular construction elements have a generally centrally disposed inner core made of a rigid form of an insulating material.

6. The system of claim 1 wherein each of said prefabricated concrete modular construction elements further comprise a cup defined within said top portion of said prefabricated concrete modular construction element, said cup further configured to receive a portion of an adjacent prefabricated concrete modular construction element therein.

7. The system of claim 1 wherein said prefabricated concrete modular construction elements are configured to withstand wearing caused by wind and water.

8. The system of claim 1 wherein said prefabricated concrete modular construction elements are configured for placement within a vertical column having an aperture configured to receive a portion of said prefabricated concrete modular construction elements.

9. The system of claim 1 wherein said prefabricated concrete modular construction elements define at least one passageway therein, said passageway configured to allow passage of a vertical stabilizing element there through.

10. The system of claim 9 wherein said vertical stabilization elements comprise reinforcing rods configured to pass through said passageways, and hold said prefabricated concrete modular construction elements in a desired position and orientation.

11. A prefabricated concrete construction log configured for use in a system of constructing structures, said concrete construction log comprised of a concrete body, said concrete body configured simulate the appearance of a natural wooden log.

12. The prefabricated concrete construction log of claim 11 wherein said concrete body is further coated with a sealant to configure said construction log to withstand wind and water damage.

13. The prefabricated concrete construction log of claim 11 wherein said concrete construction log defines at least one passageway therein, said passageway configured to allow passage of a structural reinforcing member there through.

14. The prefabricated concrete construction log of claim 11 wherein said log is configured to contain a reinforcing frame therein.

15. The prefabricated concrete construction log of claim 11 wherein said log is configured to contain a rigid insulating portion.

16. The prefabricated concrete construction log of claim 11 wherein said log is configured to contain

17. The prefabricated concrete construction log of claim 11 wherein said concrete construction log further comprises a top side, a bottom side, a front side and a back side, said top side and said bottom sides each configured to be generally flat and configured to permit stable stacking of a plurality of said prefabricated concrete construction logs thereupon.

18. The prefabricated concrete construction log of claim 11 wherein said concrete is colored to provide a wood like appearance to said prefabricated concrete construction log.

19. A method for creating a prefabricated concrete construction log configured for use in constructing structures having a log construction appearance said method comprising the steps of:
placing a rigid insulating core within a central portion of a mold, said mold configured to form a structure having an appearance of a natural wooden log;
placing a reinforcing structure within said mold around said rigid insulating core;
filling said mold with a concrete composition configured to form a hardened matrix having desired structural strength, weathering resistance and aesthetic qualities.

20. The method for creating a prefabricated concrete construction log configured for use in constructing structure having a log construction appearance of claim 17 wherein said reinforcing structure comprises a plurality of generally C-shaped re-bar portions elements placed in an orientation wherein an open portion of said C-shaped re-bar portion is oriented downward toward a bottom side of said prefabricated concrete construction log.
